(19) United States
(12) Patent Application Publication
(10) Pub. No.: US 2012/0251828 A1
(43) Pub. Date: Oct. 4, 2012

(54) SHELL AND MANUFACTURING METHOD

(75) Inventors: Mu-Chi HSU, Tu-Cheng (TW); Shao-Ming FU, Tu-Cheng (TW)

(73) Assignee: HON HAI PRECISION INDUSTRY CO., LTD., Tu-Cheng (TW)

(21) Appl. No.: 13/276,313

(22) Filed: Oct. 18, 2011

(30) Foreign Application Priority Data
Mar. 30, 2011 (TW) 100111149

(51) Int. Cl. B32B 9/04; B32B 21/04; B32B 37/14; B32B 27/06; B32B 37/02; B32B 37/12

(52) U.S. Cl. 428/412; 156/242; 428/513; 428/537.1

(57) ABSTRACT

A method for manufacturing a shell includes the following steps. A diaphanous mold having a cavity is provided. A plastic layer is disposed on a surface of the cavity of the diaphanous mold. A glue layer is disposed on the plastic layer. A substrate is disposed on and contacting the glue layer. The glue layer is solidified such that the substrate is adhered on the plastic layer by the solidified glue layer. The shell which comprises the substrate, the glue layer, and the plastic layer is separated from the diaphanous mold.

### CROSS-REFERENCE TO RELATED APPLICATIONS

This application claims all benefits accruing under 35 U.S.C. §119 from Taiwan Patent Application No. 100111149, filed on Mar. 30, 2011 in the Taiwan Intellectual Property Office, the disclosure of which is incorporated herein by reference.

### BACKGROUND

1. Technical Field

The present disclosure relates to a shell and a method for manufacturing the shell.

2. Description of Related Art

The development of portable electronic devices such as mobile phones, music players, and personal digital assistants has allowed people to express themselves through the use of technology. The appearance of these portable electronics devices are an important selling point. A metal layer or a plastic layer is usually formed on the surface of the portable electronic device, or the portable electronic device is assembled with a metal housing or a plastic housing, to give mechanical strength to these portable electronic devices.

A wood substrate is usually adhered on the on the outer surface of the metal layer or the plastic layer to improve the appearance of the portable electronic devices. However, the wood substrate could be damaged during the manufacturing process of the portable electronic devices, leaving a mottled appearance.

What is needed, therefore, is to provide a shell of the portable electronic device and a method for manufacturing the same that can overcome the above-described shortcomings.

### BRIEF DESCRIPTION OF THE DRAWINGS

Many aspects of the disclosure can be better understood with reference to the drawings. The components in the drawings are not necessarily drawn to scale, the emphasis instead being placed upon clearly illustrating the principles of the present disclosure. Moreover, in the drawings, like reference numerals designate corresponding parts throughout the views.

FIG. 1 is a flow chart of one embodiment of a method for manufacturing a shell.

FIG. 2 is a schematic view of one embodiment of a diaphanous mold.

FIG. 3 is a schematic view of one embodiment of a method for solidifying a glue layer of a shell.

FIG. 4 is a cross-sectional view of one embodiment of a shell.

### DETAILED DESCRIPTION

The disclosure is illustrated by way of example and not by way of limitation in the figures of the accompanying drawings in which like references indicate similar elements. It should be noted that references to “an” or “one” embodiment in this disclosure are not necessarily to the same embodiment, and such references mean at least one.

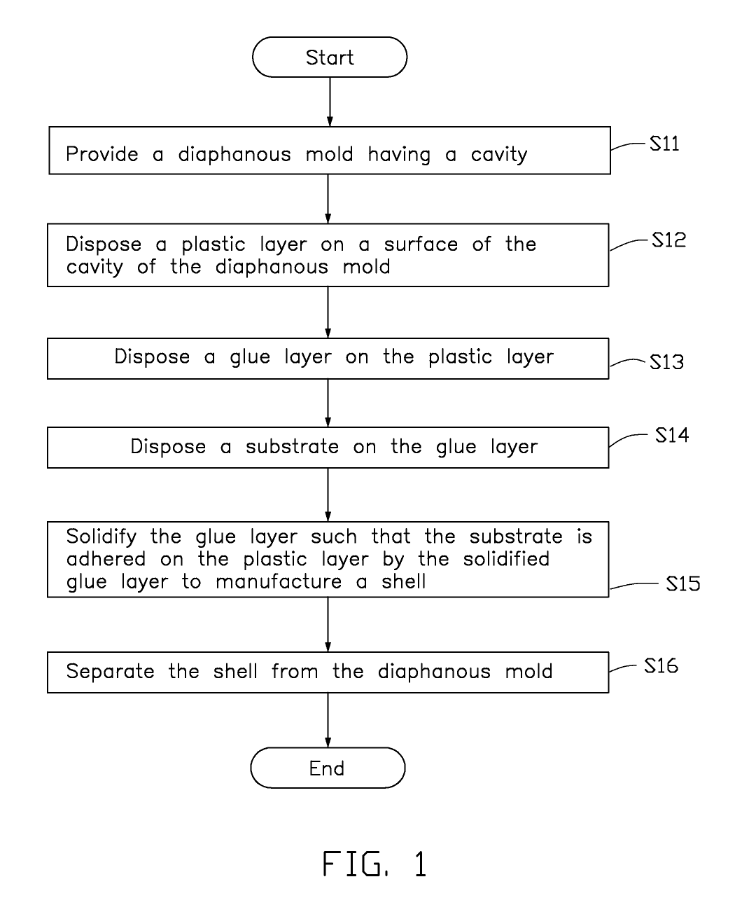

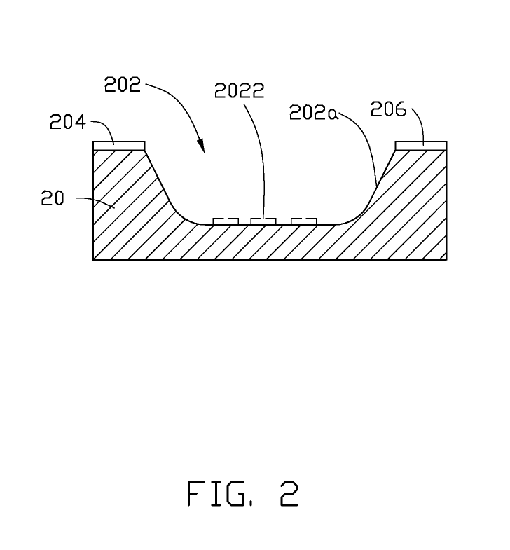

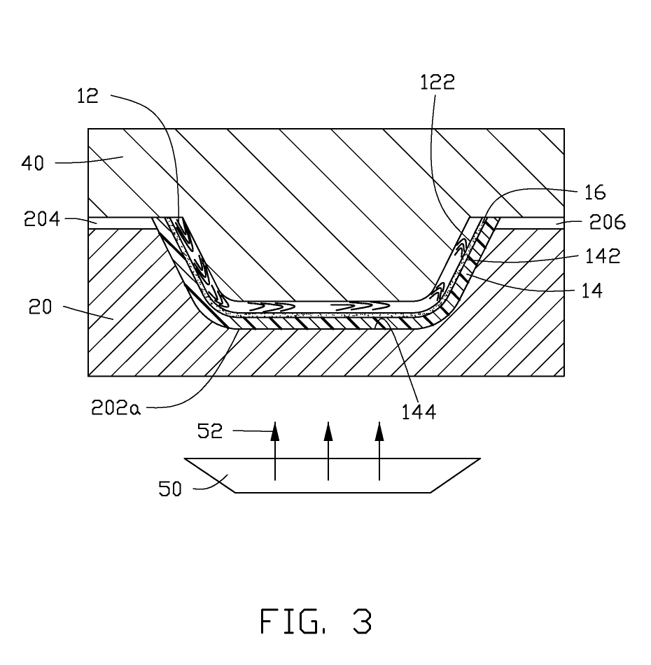

Referring to FIG. 1, FIG. 2, and FIG. 3, one embodiment of a method for manufacturing a shell includes:

(S11), providing a diaphanous mold 20 having a cavity 202;

(S12), disposing a plastic layer 14 on a surface 202a of the cavity 202 of the diaphanous mold 20;

(S13), disposing a glue layer 16 on the plastic layer 14;

(S14), disposing a substrate 12 on the glue layer 16;

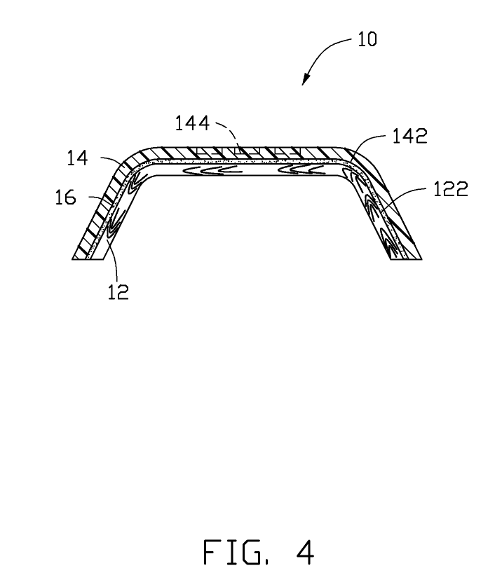

(S15), solidifying the glue layer 16 such that the substrate 12 is adhered on the plastic layer 14 by the solidified glue layer 16 to form the shell 10 (see FIG. 4); and

(S16), separating the shell 10 from the diaphanous mold 20.

Referring to FIG. 2, in the step (S11), the diaphanous mold 20 having the cavity 202 includes a pouring gate 204 and an exhaust gate 206. The cavity 202 has the surface 202a. In one embodiment, the shape of the cavity 202 is concave. The pouring gate 204 and the exhaust gate 206 can be oppositely disposed on the diaphanous mold 20.

Optionally, the method for manufacturing the shell can further include a step of prefabricating a pre-pattern 2022 on the surface 202a of the cavity 202 of the diaphanous mold 20. The pre-pattern 2022 is prefabricated on the surface 202a of the cavity 202 of the diaphanous mold 20 by sand blasting, encaustic sintering, or three-dimensional (3D) glass printing. The 3D glass printing, known as a vitraglyphic process, is a process of creating a glass object with a 3D printer. In detail, spectrum glass and binder are mixed with each other to form a spectrum glass binder, and then the 3D printer prints a pattern with 3D appearance with the spectrum glass binder. Finally, the spectrum glass binder is heated to form a glass pattern. In one embodiment, the pre-pattern 2022 is prefabricated on the surface 202a of the cavity 202 of the diaphanous mold 20 by the 3D glass printing. The diaphanous mold 20 is glass.

Referring to FIG. 3, in the step (S12), one embodiment of a method for disposing the plastic layer 14 on the surface 202a of the cavity 202 of the diaphanous mold 20 includes:

(S12a), matching a core mold (not shown) with the diaphanous mold 20; and

(S12b), pouring plastic into the cavity 202 of the diaphanous mold 20 via the pouring gate 204 to form the plastic layer 14 on the surface 202a of the cavity 202 of the diaphanous mold 20.

In the step (S12b), air between the core mold and the diaphanous mold 20 is exhausted via the exhaust gate 206 when the plastic is poured into the cavity 202 of the diaphanous mold 20 via the pouring gate 204.

In the step (S12), another embodiment of a method for disposing the plastic layer 14 on the surface 202a of the cavity 202 of the diaphanous mold 20 includes:

(S12c), fabricating the plastic layer 14 having a shape corresponding to the shape of the cavity 202 of the diaphanous mold 20; and (S12d), placing the plastic layer 14 in the cavity 202 of the diaphanous mold 20.

In the step (S12c), the plastic layer 14 is fabricated by a compressing force, extrusion, blowing, or calendering molding. The plastic layer 14 is formed by transparent material, such as polycarbonate (PC), polyethylene (PE), polystyrene (PS), or polymethyl methacrylate (PMMA).

In the step (S13), the glue layer 16 can be formed using light curable resin or thermal curable resin. The light curable resin includes ultraviolet curable resin or visible light curable resin. In one embodiment, the glue layer 16 is formed by ultraviolet curable resin.

In the step (S14), the substrate 12 has a surface 122. A shape of the surface 122 of the substrate 12 corresponds to the shape of the cavity 202 of the diaphanous mold 20. One embodiment of a method for disposing the substrate 12 on the glue layer 16 includes:

(S14a), providing a holding device 40; and

(S14b), fixing the substrate 12 on the glue layer 16 with the holding device 40.

In the step (S14b), the holding device 40 can adjust a position of the substrate 12 to fully adhere the surface 122 of the substrate 12 on the glue layer 16. The substrate 12 can be a wood substrate formed by solid wood or composite board material. The solid wood material can be walnut, teak, pinewood, china fir, or bamboo. In one embodiment, the substrate 12 is the wood substrate which is formed from walnut.

In the step (S15), one embodiment of a method for solidifying the glue layer 16 includes:

(S15a), providing a curing device 50; and

(S15b), obtaining a light 52 from the curing device 50.

In the step (S15a), the curing device 50 is disposed outside of the diaphanous mold 20. In the step (S15b), light 52 irradiates through the diaphanous mold 20 and solidifies the glue layer 16. Thus, the substrate 12 is adhered on the plastic layer 14 by the solidified glue layer 16 to form the shell 10. The light 52 from the curing device 50 can be ultraviolet, infrared light, laser, or halogen light. In one embodiment, the light 52 is ultraviolet.

In the step (S16), one embodiment of a method for separating the shell 10 includes:

(S16a), stripping the plastic layer 14 form the cavity 202 of the diaphanous mold 20; and

(S16b), stripping the substrate 112 from the holding device 40 to obtain the shell 10.

Referring to FIG. 4, one embodiment of a shell 10 manufactured by the method as illustrated in FIG. 1 includes a substrate 12, a plastic layer 14, and a glue layer 16. The substrate 12 has a surface 122. The plastic layer 14 has an internal surface 142 and an outer surface 144 opposite to the internal surface 142. The glue layer 16 is disposed on the internal surface 142 of the plastic layer 14. The substrate 12 is adhered on the plastic layer 14 with the glue layer 16. The outer surface 144 of the plastic layer 14 corresponds to the surface 202a of the cavity 202 of the diaphanous mold 20. In the method as illustrated in FIG. 1, if the pre-pattern 2022 is prefabricated on the surface 202a of the cavity 202 of the diaphanous mold 20, the outer surface 144 of the plastic layer 14 will also have the pre-pattern 2022. In one embodiment, the outer surface 144 is a 3D molding surface.

Accordingly, the present disclosure is capable of providing a method for manufacturing a shell, which can improve the elegant appearance and strength of the shell. In addition, the shell can be easily manufactured because the light via the diaphanous mold solidifies the glue layer between the substrate and the plastic layer.

Finally, it is to be understood that the above-described embodiments are intended to illustrate rather than limit the present disclosure. Variations may be made to the embodiments without departing from the spirit of the disclosure as claimed. Elements associated with any of the above embodiments are envisioned to be associated with any other embodiments. The above-described embodiments illustrate the scope of the disclosure but do not restrict the scope of the disclosure.

Depending on the embodiment, certain of the steps of methods described may be removed, others may be added, and the sequence of steps may be altered. It is also to be understood that the description and the claims drawn to a method may include some indication in reference to certain steps. However, the indication used is only to be viewed for identification purposes and not as a suggestion as to an order for the steps.

What is claimed is:

1. A method for manufacturing a shell, comprising:
providing a diaphanous mold having a cavity, wherein the cavity has a surface and a shape;
disposing a plastic layer on the surface of the cavity of the diaphanous mold;
disposing a glue layer on the plastic layer;
disposing a substrate on the glue layer, wherein the substrate is contacting the glue layer;
solidifying the glue layer such that the substrate is adhered on the plastic layer by the solidified glue layer; and
separating the shell from the diaphanous mold, the shell comprising the substrate, the glue layer, and the plastic layer.

2. The method as claimed in claim 1, further comprising:
prefabricating a pre-pattern on the surface of the cavity of the diaphanous mold.

3. The method as claimed in claim 2, wherein the pre-pattern is prefabricated on the surface of the cavity of the diaphanous mold by sand blasting, encaustic sintering, or three-dimensional glass printing.

4. The method as claimed in claim 1, wherein the diaphanous mold comprises a pouring gate.

5. The method as claimed in claim 4, wherein the step of disposing a plastic layer on the surface of the cavity of the diaphanous mold comprises:
matching a core mold with the diaphanous mold; and
pouring plastic into the cavity of the diaphanous mold via the pouring gate to form the plastic layer on the surface of the cavity of the diaphanous mold.

6. The method as claimed in claim 1, wherein the step of disposing a plastic layer on the surface of the cavity of the diaphanous mold comprises:
fabricating the plastic layer having a shape corresponding to the shape of the cavity of the diaphanous mold; and
placing the plastic layer in the cavity of the diaphanous mold.

7. The method as claimed in claim 1, wherein the step of disposing a substrate on the glue layer comprises:
providing a holding device; and
fixing the substrate on the glue layer with the holding device.

8. The method as claimed in claim 1, wherein the substrate is a wood substrate formed by solid wood material or composite board material.

9. The method as claimed in claim 8, wherein the solid wood material is walnut, teak, pinewood, china fir, or bamboo.

10. The method as claimed in claim 1, wherein the plastic layer is polycarbonate (PC), polyethylene (PE), polystyrene (PS), or polymethyl methacrylate (PMMA).

11. The method as claimed in claim 1, wherein the glue layer is light curable resin or thermal curable resin.

12. The method as claimed in claim 11, wherein the light curable resin is ultraviolet curable resin or visible light curable resin.

13. The method as claimed in claim 1, wherein the step of solidifying the glue layer comprises:
providing a curing device; and
obtaining a light from the curing device,
wherein the glue layer is solidified by the light.

14. The method as claimed in claim 13, wherein the light obtained from the curing device is ultraviolet, infrared light, laser, or halogen light.

15. A shell, comprising a plastic layer, a substrate, and a glue layer adhering the substrate to the plastic layer, wherein the glue layer is disposed on the plastic layer, the substrate is disposed on the glue layer to contact the glue layer, and the glue layer is solidified such that the substrate is adhered on the plastic layer by the solidified glue layer.

16. The shell as claimed in claim 15, wherein the plastic layer comprises an internal surface and an outer surface opposite to the internal surface, and the glue layer is disposed on the internal surface of the plastic layer.

17. The shell as claimed in claim 15, wherein the glue layer is formed by ultraviolet curable resin.
